(19) United States
(12) Patent Application Publication
(10) Pub. No.: US 2020/0123404 A1
(43) Pub. Date: Apr. 23, 2020

(54) OIL PAINT ADDITIVE COMPOSITIONS

(71) Applicant: Greta Waller, Indianapolis, IN (US)

(72) Inventor: Greta Waller, Indianapolis, IN (US)

(21) Appl. No.: 16/164,102

(22) Filed: Oct. 18, 2018

(51) Int. Cl. C09D 17/00

(52) U.S. Cl. CPC C09D 17/002

(57) ABSTRACT

The present disclosure relates to a composition for oil paint additive. The disclosed composition provides shorter oxidation process, has better UV resistance, is toxic free, and eliminates the need to varnish 1. In accordance with one embodiment of the present disclosure, the disclosed composition primarily comprises stand oil, drying oil, mica powder, fumed silica, Canada balsam, pulverized glass and spike oil.

### FIELD OF THE DISCLOSURE

The present disclosure generally relates to oil paint additive compositions. More specifically, the present disclosure provides various oil paint additive compositions that are ultraviolet (UV) resistant, hazardous/toxic solvent free, eliminates the need to varnish, and have shorter oxidation process than traditional oil paint additives without compromising traditional oil painting techniques. Some disclosed oil paint additive compositions also create fractalizing effects.

### BACKGROUND OF THE INVENTION

Oil paintings are revered because of their luminosity. Oil paints used for oil paintings are usually created by combining a binder, a drying oil and with different colored pigments. Oil paint is a slow-drying paint that commonly consists of particles of pigment suspended in a drying oil. Layers of polymerized oil suspending pigment allow for refraction and diffraction to occur which creates depth within the painting. The viscosity of the paint may further be modified by the addition of a solvent such as turpentine or white spirit. When the solvent evaporates, the paint is left dry and matte. Varnish may also be added to the dried surface for protection against moisture which also increases and preserves the glossiness of the dried oil paint film. Historically, varnishes are made of various shellacs, soft/hard (fossil) resins, and oleoresins. However, to make a varnish, these materials need to be diluted in toxic solvents. Further, varnishing a painting when the layers of oil and pigment beneath have not fully oxidized will result in possible cracking and/or “blooming”, which is a cloudy appearance in the varnish caused by trapped moisture.

Many ingredients used in the conventional oil paints or oil paint additives have various drawbacks. For examples, conventional oil paints usually have a lengthy oxidation process because they use oils that take a long time to polymerize. The addition of wax in some conventional oil paints may further delay the drying. Conventional oil paints are made this way largely due to the need to increase their shelf-life. Most conventional oil paints or oil paint additives take about ten days to dry. Further, many drying oils used in conventional oil paint will turn yellow after time which will alter the hue of the color in the painting. While there are conventional oil paints or oil paint additives with shorter oxidation processes, most of them use toxic siccatives to induce drying. Forcing a paint mixture to dry faster through siccatives can result in a brittle layer on the oil paint.

Another important ingredient commonly used in oil paint additives/varnishes is resin. Resin is usually added to paint additive for few reasons. First, a mixture of drying oil and resin was developed as a protective varnish for oil paint which maintains the oil paint's brilliance, makes the paint durable and protects the paint against moisture. Painting oils without resin have various disadvantages such as yellowing and lack of brilliance. Second, resin is used within oil paint additives to increase drying time, retain brilliance, add optical clarity and more durability within the layers of a painting. The slow drying rate of oil causes paint mixtures to muddy from overmixing. The use of resin has stabilizing effects when added into an oil paint additive. Resin has a stabilizing effect due to its clarity, non-yellowing, and fast-drying nature. Resin's sticky, viscous characteristic holds the drying oil in place until the paint surface solidifies. Third, resins are wholly or partially soluble in oils and solvents. After they have been diluted, they can easily intermix with drying oils. Incorporating resin within the layers of a painting creates greater clarity than drying oils. Resins are also used to dilute a paint for glazing because of their superior optical properties.

Natural resins come from trees. They can be hard or soft and can have high optical qualities which are desired by artists. However, in its raw form, natural resins are hard fossilized rocks or so vicious and sticky they will not dry. Resins are soluble in oils, but the solution must be heated extensively which compromises the elasticity of the oil. Volatile solvents such as turpentine, gasoline, naphtha, benzol, and/or Toluol (Toluene) are often used by conventional oil paint additives to dissolve the resins. However, these organic solvents can be hazardous and toxic to users because of their volatile nature. Their vapor can irritate the skin and eyes, damage the lungs and respiratory system, as well as the central nervous system when inhaled, and cause renal failure when ingested, among other things. While mineral spirits such as odorless mineral spirits that contain petroleum distillates can provide the same effects as organic solvents and may appear to pose as safer alternatives, they may be misleading because the fumes produced by mineral spirits are still evaporating even without odor and can still be hazardous. These toxic solvents are also combustible and pose fire hazard.

Further, conventional oil paints do not have sufficient ultraviolet (UV) resistance, so they tend to turn yellow with age. In addition, many conventional oil paints rely on synthetic resins, which demand the use of powerful toxic solvents to dilute in order to manipulate them. For examples, synthetic resins such as Acryloid and polymers have optical properties that are inferior to the refraction properties than natural resins, thereby making the resulted paintings to lack depth. Synthetic resins may not be lightfast.

Accordingly, there exists a need for an improved oil paint additive that is UV resistant, dries quickly without toxic siccatives, utilizes a highly desired resin that is not required to dissolve with hazardous solvents, is toxic free, minimizes cracking, diminishes the need to varnish, optionally creates fractalization and still provides the desired characteristics yielded by traditional painting additives.

### SUMMARY OF THE INVENTION

Objectives of the present disclosure are to provide compositions for oil paint additives that are toxic free, UV resistant, durable yet flexible, retain luster upon drying, have a shorter oxidation process, and optionally provide fractalization when mixed properly while painting.

In accordance with one embodiment of the present disclosure, a composition for an oil paint additive is disclosed. The composition comprises 1) 10-25% by volume of stand oil; 2) 35-65% by volume of drying oil; 3) 1-5% by volume of mica powder; 4) 10-25% by volume of fumed silica; 5) 1-9% by volume of Canada balsam; 6) 1-7% by volume of pulverized glass; and 7) 5-11% by volume of spike oil. Preferably, the drying oil is selected from a list comprising refined linseed oil, cold-pressed linseed oil, sun-thickened linseed oil, sun-bleached linseed oil, walnut oil, safflower oil, poppy oil, sunflower oil, Tung oil, vernonia oil, stillingia oil, grapeseed oil, perilla oil, soybean oil, hempseed oil or a combination thereof. Other drying oils such as almond oil, sesame oil can also be used.

The disclosed composition proposes a new oil painting additive that overcomes the drawbacks of traditional oil paint additives. For examples, it has a shorter oxidation process and uses a natural essential oil to cut the resin into the additive verses using a very toxic solvent such as turpentine, benzine, or naphtha. The disclosed composition also does not use a synthetic resin and comprises fractalization upon shaking the additive itself and mixing in oil paints, which promotes proper mixing which in turn avoids cracking in the oxidation and polymerization process of drying and aging. The use of mica powder within the additive makes it UV resistant. Mica also protects against weathering, provides a barrier to moisture, and helps adhesion which increases protection against corrosion. Since mica particles disperse in a lamellar manner, this can result in a lamella that reflects radiation from the sun. Mica protects organic binders against degradation by UV rays. Mica also relieves internal stresses during film coalescence. This inhibits cracking. Together, mica in resin creates a barrier to negative effects of chemicals. Mica is natural and non-toxic and not detrimental to the optical properties of resins and drying oils. As such, the disclosed composition is UV resistant, and toxic solvent free. It also eliminates the need to varnish the painting later because the disclosed composition contains the natural resin that promotes luminosity and brilliance. The painting painted with the disclosed composition is less likely to crack over time as well.

These and other features, aspects and advantages of the present invention will become better understood with reference to the following drawings, description and claims.

### DETAILED DESCRIPTION OF THE PREFERRED EMBODIMENT(S) AND INVENTION

The following description is not to be taken in a limiting sense but is made merely for the purpose of illustrating the general principles of the disclosure, since the scope of the disclosure is best defined by the following claims. Various inventive features are described below that can each be used independently of one another or in combination with other features.

Broadly, embodiments of the present disclosure generally relate to a composition for an oil paint additive. In one embodiment of the present disclosure, the disclosed composition comprises stand oil, drying oil, mica powder, fumed silica, Canada balsam, spike oil and optionally pulverized glass. Preferably, the disclosed composition comprises approximately 10-25% by volume of stand oil, 35-65% by volume of drying oil, 1-5% by volume of mica powder, 10-25% by volume of fumed silica, 1-9% by volume of Canada balsam, 5-11% by volume of spike oil and 1-7% by volume of pulverized glass.

In general, stand oil is a partially polymerized but unoxidized linseed oil that is typically made by heating to 300° C. without oxygen. A thick, light yellow, viscous oil that is consistency of thick honey. The heat-bodied oil is too viscous of a binder to use by itself for painting due to its long drying time. Its properties are that it yellows less than linseed oil, is self-leveling giving a smooth enamel-like surface when wet or dry.

Drying oil generally refers to an oil that hardens to a tough and solid film after a period of exposure to air. Preferably, the drying oil should be selected from one or more of the following drying/semi-drying oils: refined linseed oil, cold-pressed linseed oil, sun-thickened linseed oil, sun-bleached linseed oil, walnut oil, safflower oil, poppy oil, sunflower oil, Tung oil, vernonia oil, stillingia oil, grapeseed oil, perilla oil, soybean oil, hempseed oil or a combination thereof. Alternatively, other types of oils such as cottonseed oil, almond oil and sesame oil can also be used. The oils can be raw, refined, cold-pressed, hot-pressed, sun-thickened, boiled or bleached. For example, if Tung oil is being used, the Tung oil may be raw Tung oil, refined Tung oil, cold-pressed Tung oil, Hot-pressed Tung oil, sun-thickened Tung oil, boiled Tung oil, bleached Tung oil or combination thereof. Below is description for some of drying oils and other ingredients used in the disclosed composition.

Linseed oil is obtained from the seeds of a flax plant. It is a light-yellow oil that is similar to olive oil. It is regarded as a good film former for paintings. The films produced are tough, resilient, but are subject to yellowing and embrittlement with age.

Refined linseed oil: after the linseed oil is extracted from the seed of the flax plant, this oil is further filtered and then washed with specific types of water (e.g., alkaline water) to remove acid impurities within the oil. The resulting product is a golden, rich & sweet-smelling oil that is composed primarily of linolenic acid.

Cold-pressed linseed oil: the purest and most desirable linseed oil that is straw yellow in color. Drying time is quicker than refined linseed oil.

Sun-thickened linseed oil: a linseed oil that is mixed with equal parts water and exposed to strong sun for 40 days. The resulting self-leveling oil is a viscous, light yellow oil that is considered a good siccative.

Sun-bleached linseed oil: made by exposing raw, cold-pressed linseed oil to sunlight in shallow enamel trays covered with clear glass but exposed to the atmosphere for a period of less than one month.

Walnut oil, which is also commonly known as “nut oil,” is denser than linseed oil. Walnut oil is a non-yellowing oil that dries faster than safflower oil and poppy oil. The fluidity of walnut oil permits a very free painting technique. Due to its dense composition, walnut oil suspends pigment well and resists separation.

Safflower oil: a light-colored oil pressed from the seeds of the safflower plant. It is considered to be both a semi-drying oil and a drying oil that produces clear and thin coats that are self-leveling. The films when dry are more brittle than linseed oil/stand oil films. Many white oil paints are made with safflower oil because it yellows less with time.

Poppy oil: the clearest of the drying oils. A clear and nearly colorless thin oil that dries to a thin, highly refractive film that embrittles with age.

Sunflower oil: a non-volatile oil pressed from the seeds of sunflower.

Tung oil or China wood oil: a drying oil obtained by pressing the seed from the nut of the tung tree (Vernicia fordii). Tung oil hardens upon exposure to air, and the resulting coating is transparent and has a deep, almost wet look.

Vernonia oil: an oil produced by vernonia galamensis. Vernonia oil is a natural epoxidized vegetable oil containing three epoxy rings and three carbon-carbon double bonds. It has several advantages over other epoxidized vegetable oils produced industrially and appears to be a very attractive raw material for three large volume industrial applications.

Stillingia oil: an oil gained by solvent from the plant seeds of the Sapium family such as, Sapium sebiferum (Chinese tallow tree) and Sapium discolor (Mountain tallow tree). It can be used as a drying agent in paints and varnishes.

Perilla oil; an edible vegetable oil derived from perilla seeds.

Grapeseed oil: an oil pressed from the seeds of grapes.

Hempseed oil or hemp oil: an oil obtained by pressing hemp seeds. Cold pressed, unrefined hemp oil is dark to clear light green in color.

Soybean oil: a vegetable oil extracted from the seeds of the soybean (Glycine max). As a drying oil, processed soybean oil can be used as a base for printing inks (soy ink) and oil paints.

Fumed silica is a nearly weightless precipitated matter that easily soaks up liquids causing them to thicken. Mixing equal parts of stand oil to fumed silica, when whipped will form a stiff-like gel that stands on up. The weight of fumed silica is determined based on a density of 2.2 g/cm3.

Mica is preferably ground dry Mica. Mica can be used as a barrier to the ingress of moisture and assists on adhesion so increasing corrosion protection. Mica protects organic binders from early degradation by light and UV rays. Mica dust also referred to as “glimmer” presents a hard-coherent barrier, which protects the underlying resin by reflecting sun radiation. Adding mica to paint will create UV resistance within each paint layer because mica particles are refractive to light and will deflect light and UV rays. It also interlocks each paint layer after it is mixed with pigments and the oil paint is polymerized. Mica also has a resistance to high and rapid temperature changes. Additional traits are that it is incombustible, resistant to acid, alkali resistant, good insulation, and is heat resistant. Mica brings out the natural hue. It is advised when mixing color that to see the actual color, just as mall amount zinc white should be added. Zinc white is a transparent white. Mica serves this purpose but is more transparent and refractive than traditional zinc white.

Canada balsam is a natural resin made from the Balsam Fir. Unlike turpentine which is commonly produced from pine trees, Canada balsam is produced from fir tree and is considered toxic free. The resin is a viscous, sticky, nearly colorless to very light-yellow resin that is amorphous when dried. Canada Balsam has a high optical quality. Since it does not crystalize with age, its optical properties do not deteriorate. It also has a high resistance from yellowing with age.

Leaded Glass/powdered glass/Pulverized glass is a luminous powder form of glass that has been pulverized by lead pipes rolling over it. Also known as Frit, ground glass is a dense cold powder that absorbs liquid easily.

Spike oil (or oil of spike) and Lavender oil are solvent distilled from a variety of lavender species. It is a strong solvent that can fully dissolve resins and mix well with oils to make painting mediums. Lavender oil and its cheaper version, spike oil, is more resinous than oil of turpentine. In general, Lavender oil is prepared from the blossoms, spike oil is prepared from the whole lavender plant. The two are powerful solvents for breaking down natural resins.

Note that the addition of mica powder to the formula serves to brings out the natural hue of the color. It is advised when mixing color that to see the actual color, just a small amount of zinc white should be added. Zinc white is a transparent white. Mica powder serves this purpose but is more transparent and refractive than traditional zinc white.

In a general sense, the above components for the disclosed composition are important because of the ration in which they are mixed. The formula contains a highly optical resin that in conjunction with the other ingredients causes the solution to fractalize upon being shaken. This action occurs while mixing the additive into the oil paint causing the paint to fully and evenly disperse. The paint/pigment mixed in with the additive saturates so well that it cancels out a need to varnish the painting in the end when dry. This is in part due to the addition of the highly optical oleoresin, Canada balsam. This resin repels dust and moisture, and will not yellow with age.

Table 1 below provides few exemplary formulations for the disclosed oil paint additive. In addition, all the formulas/compositions below will produce fractalization effects. For purpose of the present disclosure, the term “fractalization” generally refers as an attribute for a painting medium when all the ingredients in the painting medium are mixed in proper ratio. Fractalization provides a frothy, gravy-like consistency mixture when shaken forms fractal like patterns within the mixture (e.g., like crystalized snowflakes). Only proper mixing of ingredients can result in fractalization and fractalization is evidence of good suspension in the painting medium. This is evident through the stable suspension of the mica pigment in the dried swatches of the medium when brushed on various surfaces. Fractalization is the appearance of the mixture.

TABLE A
Exemplary Formulas for Disclosed Composition

| Composition | Formula | Color | Characteristics |
|---|---|---|---|
| Homage | 200 ml stand oil, | Gold | Great for direct painting |
| | 600 ml drying oil (200 | | Silky, but slick |
| | cold pressed linseed | | Denser and flatter medium when |
| | oil & 400 ml refined | | applied to a surface with paint |
| | linseed oil) | | Sparkly |
| | 25 ml mica powder | | Slightly sticky |
| | 200 ml fumed silica | | Very transparent |
| | 75 ml Canada balsam | | |
| | 50 ml pulverized glass | | |
| | 100 ml spike oil | | |
| A | 1.3 oz stand oil | Gold | Since the additive created from this |
| | 3.9 oz refined linseed | | composition has a thick consistency, |
| | oil | | it is recommended that equal parts of |
| | 0.27 oz mica powder | | paint (e.g., color pigment) and |
| | 1.3 oz fumed silica | | additive are mixed for direct |
| | 0.32 oz Canada | | painting. |
| | balsam | | This composition serves to create a |
| | 0.37 oz pulverized | | nice, substantial, hearty, glaze- like |
| | glass | | oil paint additive that has |
| | 0.64 oz spike oil | | tremendous covering ability. |
| | | | A nice substantial, hearty glaze oil |
| | | | paint is attained immediately when a |
| | | | 1/4 paint is mixed with the additive. |
| | | | This mixture allows for a nice |
| | | | transparent glaze where it is visible |
| | | | to see an even suspension of pigment |
| | | | in the liquid medium. This is good |
| | | | for eliminating the chance of |
| | | | cracking. |
| | | | It has nice layers. |
| | | | Colors get less muddy in mixing |
| | | | process due to the right consistency. |
| | | | This composition typically dries in |
| | | | two days. |
| | | | Very transparent |
| B | 1.3 oz stand oil | Sparkly | Less paint is required to add to the |
| | 3.9 oz walnut oil | Cream | additive. |
| | 0.27 oz mica powder | | Smooth. |
| | 1.3 oz fumed silica | | Less soft and fuzzy than |
| | 0.32 oz Canada | | composition A. |
| | balsam | | Not as runny as composition A. |
| | 0.37 oz pulverized | | Brushstrokes stay in place but retain |
| | glass | | their fluidity. |
| | 0.64 oz spike oil | | The additive is able to be applied |
| | | | extremely smoothly onto bare |
| | | | primed ground. |
| | | | Suitable for slower, more detail- |
| | | | oriented painting applications. |
| | | | The addition of walnut oil provides |
| | | | the medium with a heavier, less |
| | | | yellowing oil compared to using |
| | | | linseed oil. |
| | | | Excellent pigment suspension. |
| | | | Additive does not separate on shelf |
| | | | in bottle (most likely due to the |
| | | | density of the nut oil allowing it to |
| | | | suspend the Mica evenly. |
| | | | When wet, the additive gives a lot of |
| | | | dimension and is glass-like. |
| | | | It is almost completely tacked up |
| | | | and dries to the touch in 4-5 days. |
| | | | It retains full saturation of color |
| | | | when mixed. |
| | | | As oxidation phase completes, |
| | | | applied colors fully resist “sinking |
| | | | in” or “flatting”. |
| | | | Very transparent |
| C | 1.3 oz stand oil | Sparkly | Consistency of composition C falls |
| | 3.9 oz refined | Cream | right between compositions A and B. |
| | safflower oil | | It is a looser medium, whereas |
| | 0.27 oz mica powder | | composition B has stiffer feeling. |
| | 1.3 oz fumed silica | | Detailed brushwork is able to be |
| | 0.32 oz Canada | | attained. |
| | balsam | | Quick and exact brushstrokes hold |
| | 0.37 oz pulverized | | their place on a vertical support. |
| | glass | | Clearer properties due to the addition |
| | 0.64 oz spike oil | | of safflower oil which is considered |
| | | | a non-yellowing drying oil. |
| | | | When wet, gives a lot of dimension |
| | | | and is glass-like. |
| | | | As oxidation phase completes, |
| | | | applied colors fully resist “sinking |
| | | | in” or “flatting”. |
| | | | Very transparent |
| D | 1.3 oz stand oil | Sparkly | Comparable to Venetian Medium |
| | 3.9 oz refined poppy | Pale White | because of its smoothness and light- |
| | oil | | handling. |
| | 0.27 oz mica powder | | Fluid, but remains in place put. |
| | 1.3 oz fumed silica | | Medium adds a fluid gel-like |
| | 0.32 oz Canada | | extendibility in addition to paint. |
| | balsam | | Stays in place. |
| | 0.37 oz pulverized | | Comparable to gouache painting |
| | glass | | characteristics. |
| | 0.64 oz spike oil | | When mixed with paint, it has a |
| | | | runny consistency, but the run is |
| | | | slow. |
| | | | As oxidation phase completes, |
| | | | applied colors fully resist their urge |
| | | | to “sink in”. |
| | | | Very transparent |
| E | 1.3 oz stand oil | Light | |
| | 3.9 oz almond oil | Pale Yellow | |
| | 0.27 oz mica powder | | |
| | 1.3 oz fumed silica | | |
| | 0.32 oz Canada | | |
| | balsam | | |
| | 0.37 oz pulverized | | |
| | glass | | |
| | 0.64 oz spike oil | | |
| F | 200 ml stand oil | Light | Looser medium than composition B. |
| | 600 ml drying oil | Pale Cream | More transparent than composition |
| | (300 safflower oil & | | B. |
| | 300 walnut oil) | | Fluidity is due to addition of |
| | 25 ml mica powder | | safflower oil, smooth, self-leveling, |
| | 200 ml fumed silica | | silky, sparkly, minor self-leveling. |
| | 75 ml Canada balsam | | |
| | 50 ml pulverized | | |
| | glass | | |
| | 100 ml spike oil | | |
| G | 200 ml stand oil | Light Pale | Holds brushstrokes exactly |
| | 600 ml drying oil | Yellow | Good coverage, self-leveling on |
| | (400 ml sesame oil, | | rigid surface. |
| | 200 ml safflower oil) | | |
| | 25 ml mica powder | | |
| | 200 ml fumed silica | | |
| | 75 ml Canada balsam | | |
| | 50 ml pulverized | | |
| | glass | | |
| | 100 ml spike oil | | |
| I | 200 ml stand oil | Yellow | Holds brushstrokes exactly. |
| | 600 ml drying oil | | Good coverage. |
| | (200 ml walnut oil, | | Self-leveling on rigid surface. |
| | 400 ml soybean oil) | | Thicker consistency. |
| | 25 ml mica powder | | Denser medium because of addition |
| | 200 ml fumed silica | | of soybean oil, good suspension, |
| | 75 ml Canada balsam | | fluid, loose gel-like consistency. |
| | 50 ml pulverized glass | | |
| | 100 ml spike oil | | |
| K | 200 ml stand oil | Light Yellow | Thicker medium, dense, slightly |
| | 600 ml drying oil | | self-leveling, but holds pigment in |
| | (100 ml soybean oil | | place, good suspension. |
| | & 500 ml refined | | |
| | linseed oil) | | |
| | 25 ml mica powder | | |
| | 200 ml fumed silica | | |
| | 75 ml Canada balsam | | |
| | 50 ml pulverized | | |
| | glass | | |
| | 100 ml spike oil | | |
| Homage | 200 ml stand oil, | Clear Pale | Translucent, milky, sparkly |
| A1 | 600 ml poppy oil | in Color | appearance. |
| | 25 ml mica powder | | Poppy oil is a slow drying oil. In |
| | 200 ml fumed silica | | this formulation, poppy will tack up |
| | 75 ml Canada balsam | | in about three days, very clear, high |
| | 50 ml pulverized | | optical properties due to the addition |
| | glass | | of two highly refractive substances, |
| | 100 ml spike oil | | smooth, good for detailed |
| | | | brushwork, can obtain very opaque |
| | | | and quick mark making, holds |
| | | | brushstrokes immediately. |
| Homage | 200 ml stand oil | Silky, | More heavy-bodied medium, holds |
| B1 | 600 ml walnut oil | Creamy and | brushstrokes, lines in brushstrokes. |
| | 25 ml mica powder | Shimmery | Slightly self-leveling. |
| | 200 ml fumed silica | Color | |
| | 75 ml Canada balsam | | |
| | 50 ml pulverized glass | | |
| | 100 ml spike oil | | |
| G1 | 200 ml stand oil, | Transparent | Very fluid, loose, good for detailed |
| | 600 ml drying oil | beige, grey, | work, thick. |
| | (Tung oil and. | light yellow | Self-leveling, holds brushstrokes. |
| | Safflower oil) | | |
| | 25 ml mica powder | | |
| | 200 ml fumed silica, | | |
| | 75 ml Canada balsam, | | |
| | 50 ml pulverized | | |
| | glass | | |
| | 100 ml spike oil | | |
| L | 200 ml stand oil, | sparkly, | Adding more fumed silica will |
| | 600 ml drying oil | creamy, gold | thicken the formula and decrease the |
| | (250 ml safflower oil, | | brilliance. |
| | 350 ml linseed oil) | | Good consistency |
| | 25 ml mica powder | | |
| | 400 ml fumed silica | | |
| | 75 ml Canada balsam | | |
| | 50 ml pulverized | | |
| | glass | | |
| | 100 ml spike oil | | |
| M | 200 ml stand oil, | Sparkly, | |
| | 600 ml drying oil | creamy, | |
| | (300 ml walnut oil | yellow gold | |
| | and 300 ml safflower | | |
| | oil) | | |
| | 25 ml mica powder | | |
| | 200 ml fumed silica | | |
| | 150 ml Canada | | |
| | balsam | | |
| | 50 ml pulverized | | |
| | glass | | |
| | 100 ml spike oil | | |

In yet another embodiment of the present disclosure, aluminum stearate powder is further added to the formula above (approximately 45 ml or 2-6% by volume). Aluminum stearate is a white, wax-like powder that dissolves in mineral spirits or hot oil. A small amount added to oil paint imparts a short, buttery consistency. Aluminum stearate powder can be added to the formula to prevent the separation of the mica and oils/resin in the formula. Although it may not prevent the mica from settling, it gives a slightly more desirable consistency to the formula. In other words, aluminum stearate can acts as a viscosity (resistance to flow) moderator, suspending agent (keeps the oil and water parts of an emulsion from separating), and thickening agent.

It should also be noted that when the term “a”, “an”, etc. is used, it is to be interpreted as “at least one” throughout the application, drawings, and claims.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A composition for an oil paint additive, the composition comprising:
10-25% by volume of stand oil;
35-65% by volume of drying oil;
1-5% by volume of mica powder;
10-25% by volume of fumed silica;
1-9% by volume of Canada balsam; and
5-11% by volume of spike oil.

2. The composition of claim 1, wherein the drying oil comprises 35-65% of cold pressed linseed oil and 40-80% of refined linseed oil.

3. The composition of claim 1, wherein the drying oil is refined linseed oil, cold-pressed linseed oil, sun-thickened linseed oil, sun-bleached linseed oil or a combination thereof.

4. The composition of claim 1, wherein the drying oil is walnut oil.

5. The composition of claim 1, wherein the drying oil is safflower oil.

6. The composition of claim 1, wherein the drying oil is poppy oil.

7. The composition of claim 1 further comprises 2-6% of aluminum stearate.

8. The composition of claim 1, wherein the drying oil comprises 40-60% of safflower oil and 40-60% of walnut oil.

9. The composition of claim 1, wherein the drying oil is Tung oil, vernonia oil, stillingia oil, grapeseed oil or a combination thereof.

10. The composition of claim 1, wherein the drying oil is perilla oil, soybean oil, hempseed oil or a combination thereof.

11. The composition of claim 1, wherein the drying oil comprises 20-40% of walnut oil and 60-80% of soybean oil.

12. The composition of claim 1, wherein the drying oil comprises 5-25% of soybean oil and 75-95% of refined linseed oil.

13. The composition of claim 1, further comprises 1-7% by volume of pulverized glass.

14. A composition for an oil paint additive, the composition comprising:
10-25% by volume of stand oil;
35-65% by volume of drying oil, wherein the drying oil is refined linseed oil, cold-pressed linseed oil, sun-thickened linseed oil, sun-bleached linseed oil, walnut oil, safflower oil, poppy oil, sunflower oil, Tung oil, vernonia oil, stillingia oil, grapeseed oil, perilla oil, soybean oil or hempseed oil;
1-5% by volume of mica powder;
10-25% by volume of fumed silica;
1-9% by volume of Canada balsam;
2-6% by volume of aluminum stearate;
1-7% by volume of pulverized glass; and
5-11% by volume of spike oil.

15. The composition of claim 14, wherein the drying oil is raw, refined, cold-pressed, hot-pressed, sun-thickened, boiled or bleached.

16. A composition for an oil paint additive, the composition comprising:
stand oil;
drying oil;
mica powder;
fumed silica;
Canada balsam;
pulverized glass; and
spike oil.

17. The composition of claim 16, wherein the drying oil comprises at least one oil selected from a list comprising refined linseed oil, cold-pressed linseed oil, sun-thickened linseed oil, sun-bleached linseed oil, walnut oil, safflower oil, poppy oil, sunflower oil, Tung oil, vernonia oil, stillingia oil, grapeseed oil, perilla oil, soybean oil, hempseed oil.

18. The composition of claim 17, wherein the drying oil is raw, refined, cold-pressed, hot-pressed, sun-thickened, boiled or bleached.

19. The composition of claim 16, wherein the ratio between the stand oil and the drying oil is 1:3 and the ratio between the stand oil and the fumed silica is 1:1.

20. The composition of claim 16 further comprises aluminum stearate.
